(19) United States
(12) Patent Application Publication
(10) Pub. No.: US 2022/0036387 A1
(43) Pub. Date: Feb. 3, 2022

(54) MULTI-FACETED LARGE-SCALE FORECASTING

(71) Applicant: S&P Global, New York, NY (US)

(72) Inventors: Antony Papadimitriou, New York, NY (US); Urjitkumar Patel, Jersey City, NJ (US); Lisa Kim, Jersey City, NJ (US); Grace Bang, New York, NY (US); Azadeh Nematzadeh, Brooklyn, NY (US); Xiaomo Liu, Forest Hills, NY (US)

(21) Appl. No.: 16/942,355

(22) Filed: Jul. 29, 2020

(51) Int. Cl. G06Q 30/02; G06N 20/20; G06N 5/04

(52) U.S. Cl. CPC G06Q 30/0202; G06Q 30/0201; G06N 5/04; G06N 20/20

(57) ABSTRACT

A method of forecasting is provided. The method comprises forecasting, with a number of univariate models, a number of company-level metrics for a company over a specified time period according to company-specific historical data. A multivariate model is also used to forecast the company-level metrics over the specified time period according to the company-specific historical data and sector-level historical data related to an industry sector to which the company belongs. The forecasts of the univariate models and the multivariate model are combined into an ensemble model, which then forecasts the company-level metrics over the specified time period.

### BACKGROUND INFORMATION

### 1. Field

The present disclosure relates generally to an improved computing system, and more specifically to a method for financial forecasting through a multi-level machine learning system.

### 2. Background

The global financial markets are greatly impacted by the forward-looking view of business conditions used by investors to make their buy and sell decisions and strategies. Therefore, financial forecasts are important drivers for many components of financial markets analysis. When equity analysts analyze the stock valuation of a company or when credit analysts assess the credit rating of a company, they both rely on accurate forecasts for the company's outlook. Generating high quality financial forecasts is not a trivial task. Well-trained financial professionals spend multiple years gaining insights to generate reliable projections.

In the prevailing research, financial forecasting is a framework of evaluating a firm's future prospects using its industry, strategy and financial performance. Even well-trained financial analysts may make notable forecasting errors. Forecast errors can be derived from the over-emphasis of past financial performance and overlook the importance of industry and strategic information.

Therefore, it would be desirable to have a method and apparatus that take into account at least some of the issues discussed above, as well as other possible issues.

### SUMMARY

An illustrative embodiment provides a computer-implemented method of forecasting. The method comprises forecasting, with a number of univariate models, a number of company-level metrics for a company over a specified time period according to company-specific historical data. A multivariate model is also used to forecast the company-level metrics over the specified time period according to the company-specific historical data and sector-level historical data related to an industry sector to which the company belongs. The forecasts of the univariate models and the multivariate model are combined into an ensemble model, which then forecasts the company-level metrics over the specified time period.

Another illustrative embodiment provides a system for forecasting. The system comprises a storage device configured to store program instructions and a number of processors operably connected to the storage device and configured to execute the program instructions to cause the system to: forecast, with a number of univariate models, a number of company-level metrics for a company over a specified time period according to company-specific historical data; forecast, with a multivariate model, the company-level metrics over the specified time period according to the company-specific historical data and sector-level historical data related to an industry sector to which the company belongs; combine the forecasts of the univariate models and the multivariate model into an ensemble model; and forecast the company-level metrics over the specified time period with the ensemble model.

Another illustrative embodiment provides a computer program product for forecasting. The computer program product comprises a computer-readable storage medium having program instructions embodied thereon to perform the steps of: forecasting, with a number of univariate models, a number of company-level metrics for a company over a specified time period according to company-specific historical data; forecasting, with a multivariate model, the company-level metrics over the specified time period according to the company-specific historical data and sector-level historical data related to an industry sector to which the company belongs; combining the forecasts of the univariate models and the multivariate model into an ensemble model; and forecasting the company-level metrics over the specified time period with the ensemble model.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a multi-faceted forecasting system in accordance with an illustrative embodiment;

FIG. 3 depicts a diagram that illustrates a node in a neural network in which illustrative embodiments can be implemented;

FIG. 4 depicts a diagram that illustrates a neural network in which illustrative embodiments can be implemented;

FIG. 5 depicts a diagram that illustrates a multi-layer perceptron in accordance with an illustrative embodiment;

FIG. 6 depicts a flowchart illustrating a process for multi-faceted, large-scale forecasting in accordance with an illustrative embodiment;

FIG. 7 is a block diagram of a data processing system in accordance with an illustrative embodiment.

### DETAILED DESCRIPTION

The illustrative embodiments recognize and take into account one or more different considerations. The illustrative embodiments recognize and take into account that Even well-trained financial analysts may make notable forecasting errors. Forecast errors can be derived from the over-emphasis of past financial performance and overlook the importance of industry and strategic information.

The illustrative embodiments also recognize and take into account that the analytical process of financial forecasting is very data driven. Financial analysts rely on multiple types of data including news, industry reports and company filings such as 10-Ks and 10-Qs.

The illustrative embodiments also recognize and take into account that financial professionals can utilize their tactical knowledge, but they have limitations on the amount of information they can process. Although it is hard for algorithms to factor in qualitative knowledge, algorithms excel in learning sophisticated insights from big data to power large scale analysis and the production of accurate financial forecasts.

The illustrative embodiments also recognize and take into account that traditionally, time series forecast technologies are mainly univariate based and statistical based. The univariate assumption considers the problem as predicting future values solely using its historical values.

The illustrative embodiments provide a generic financial forecasting framework applicable to any company and financial metric in financial statement such as income statement, cash flow and balance sheet. The illustrative embodiments both univariate and multivariate time series machine learning models that are combined to generate accurate forecasts from heterogeneous company-specific and sector-specific financial data.

The illustrative embodiments can forecast corporate financial metrics such as income statement, balance sheet, and cash flow in large scale for tens of thousands of companies at once.

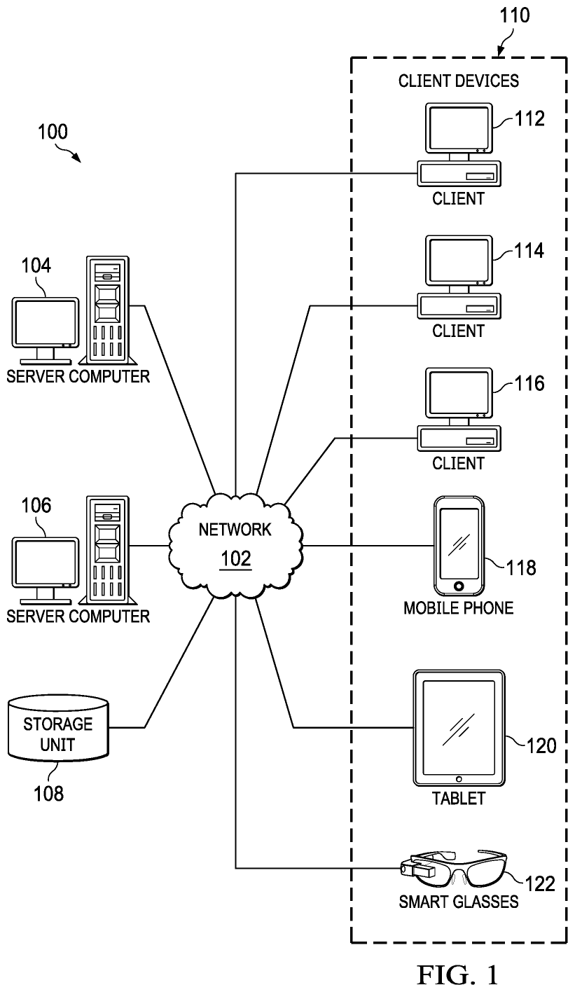

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet computer 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

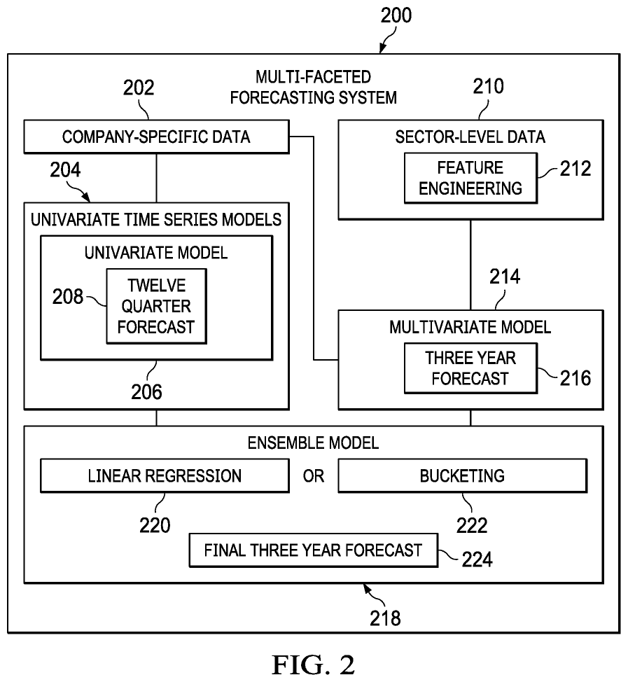

FIG. 2 depicts a block diagram of a multi-faceted forecasting system in accordance with an illustrative embodiment. Forecasting system 200 might be implemented in data processing system 100 in FIG. 1.

Forecasting system 200 utilizes both company-specific historical data 202 and sector-level historical data 210 to make financial forecasts for a company. As mentioned above, the univariate assumption used in traditional forecasting as a financial time series forecast problem. A such, future values are predicted solely using their historical values. The illustrative embodiments solve this problem by using the multivariate assumption that the future values are not only determined by the past values but also other metrics like total assets, and other sector-level signals like GPD, commodity prices, etc.

Analysts typically focus on one industry sector such as technology, oil & gas, retail, metal & mining, etc. Although there are distinctions in sectors and nuances in sectors, some categories of quantitative are commonly used in financial forecasts across all companies. These categories include financial data, macroeconomic data, commodity prices, and management guidance. Financial data is used because the most straightforward and useful data to predict future financial metrics are their past values, but all items from the three financial statements (income, balance, and cash flow) can potentially contribute to the prediction of each item like revenue. Macroeconomic data such as gross domestic product (GDP) and Consumer Price Index (CPI) can affect the business operations of a company. If the sale prices of certain companies' goods are determined by the commodity market, then commodity data is typically included as a factor. For example, the profit of oil & gas sector is tightly correlated with oil and natural gas prices. Management Guidance comprises prediction of near-term profit and loss provided by senior management in an earnings call and the subsequent financial reporting, which is a valuable data point to aid independent predictions.

Company-specific data 202 might include, e.g., revenue, cost of goods sold, research and development expenses, gross margin, depreciation, net working capital, accounts receivable, earnings before interest, taxes, depreciation, and amortization (EBITDA), and management guidance.

Company-specific data 202 is fed into a number of univariate time series models 204. The most widely used statistical/time series models are the AutoRegressive Integrated Moving Average (ARIMA) family and Error, Trend, Seasonal (ETS) family models. These models require little data for model fitting and are relatively easy to interpret. Because of this characteristic, statistical models are well suited to fit individual models for each time series (i.e. each financial metric and each company) to capture a fixed set of patterns. The models which show promising results on time series forecasting problems are deep learning (DL) based models such as multi-later perceptrons (MLP), recurrent (RNN) and convolutional (CNN) neural networks, and Seq2Seq models. These models can learn the nonlinear behavior of the data better than statistical methods but do require a sufficient amount of data points to train well.

Univariate models 204 might include Holt trend method, Prophet model, multi-layer perceptron, sequence-to-sequence. Holt method is an extension of simple ETS by allowing forecasting of data with trends. It is parameterized by two smoothing parameters, one fore level (smoothed value) and one for trend (slope) as follows:

y_{i,t+1}=l_{i,t}+ρb_{i,t} forecast

l_{i,t}=αy_{i,t}+(1−α)+(l_{i,t-1}+ϕb_{i,t-1}) level

b_{i,t}=β(l_{i,t}−l_{i,t-1})+(1−β)ϕb_{i,t-1} trend

where l denotes an estimate of the level of the series and α∈(0, 1) is its smoothing parameter; b represents an estimate of trend and β∈(0, 1) is its smoothing parameter; while ρ is a trend coefficient and ϕ is a dampening factor.

When ρ is a linear function and ϕ=1, the Holt model is called “linear trend model” which uses the additive function to model the trend. The “exponential trend model” uses the exponential function of p to model the trend. The “additive damped trend model” adds an extra smoothing parameter for dampening. The linear method models a constant trend (increasing or decreasing) indefinitely into the future, which is an unrealistic assumption. In fact, it tends to over-forecast for many companies. Therefore, by introducing the dampening parameter ϕ, the “additive damped” model flattens the trend after certain steps into the future.

Prophet Model is an open source forecasting tool which was developed by Facebook. It was observed that Prophet was able to learn seasonal behavior well and is also robust to missing data. Prophet is a decomposable time series model with three main subcomponents: trend, seasonality, and holiday effects. For time series i:

y_{i,t}=g_{i,t}+s_{i,t}+h_{i,t}+∈_{i,t}

where g_{i,t} is the trend function which models nonperiodic changes in the value of the time series, s_{i,t} represents periodic changes (e.g., weekly and yearly seasonality), and h_{i,t} represents the effects of holidays which occur on potentially irregular schedules over one or more days. The error term ∈_{i,t} represents any idiosyncratic changes which are not accommodated by the model.

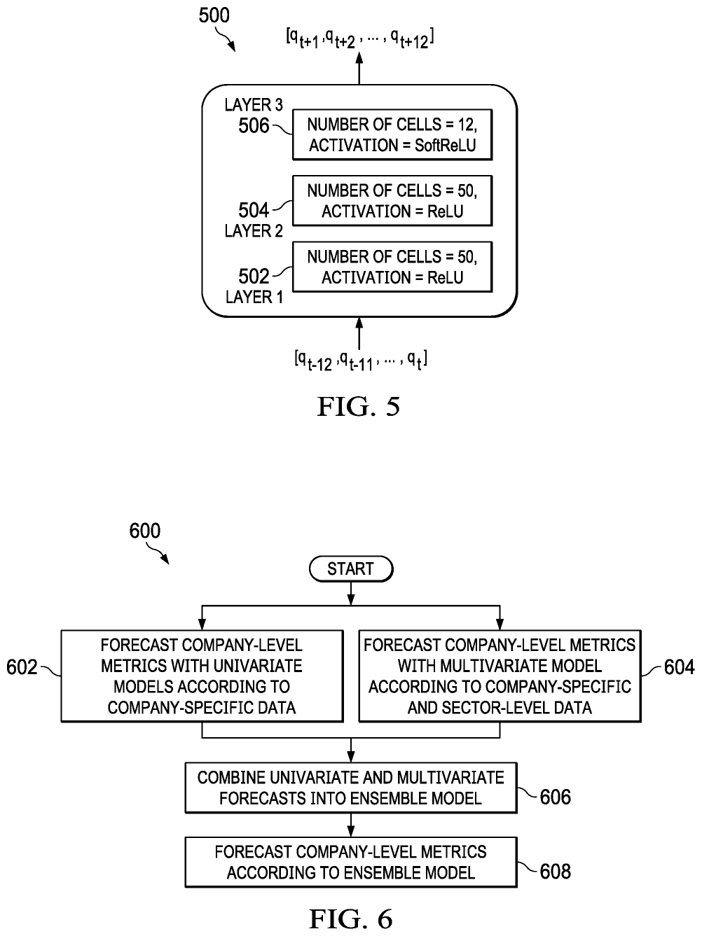

Multi-layer perceptron (MLP) is one of the simplest feed forward neural networks and is particularly suitable when long time series data are not available for companies (see FIG. 5).

The sequence-to-sequence (Seq2Seq) model uses a recurrent network (RNN) or convolutional neural network (CNN) as an encoder and two MLPs, global and local, as a decoder.

Each Univariate model 206 within the univariate models 204 generates a forecast 208 of company-level financial metrics for the company covering a specified time period. In the present example, the time period of the forecast 208 is 12 quarter (three years), which is common in financial projection methodology, especially credit rating analysis. However, the method of the illustrative embodiments can be applied to other length time periods.

Sector-level historical data 210 along with the company-specific historical data 202 is fed into a multivariate machine learning model 214. Sector-level historical data 210 might include, e.g., real GDP, CPI, unemployment rate, interest rates, tax rates, commodity prices, and management guidance.

Feature engineering 212 might be applied to the sector-level data 210 to extract features from the raw data via data mining techniques. This extraction can be performed according to domain knowledge and is used to refine the input dataset for machine learning algorithms to improve performance.

In contrast to the univariate assumption, the multivariate models consider that the independent values in the future yₜ₊ₕ of a series can be predicted by its historical values {y_{l:t}} and a set of dependent and co-variate features {x_{l:t}} that are related to y. The quantitative data that financial analysts use to come up with projections manually can be used for the co-variate feature vectors. They are converted into the feature set x.

For the financial, macroeconomic, and commodity features, the following metrics might be computed: (1) rolling change—the percentage change from previous values as a rolling figure; (2) rolling sum—the rolling sum from previous values; (3) change from previous—the percentage change from the previous value.

For the management guidance features the annual change metric might consist of a forecast percentage change for one, two, and three years into the future relative to the current year.

Given that each data type, d, has D_{q}(d) metrics and its corresponding feature calculation has Dc(d) methods, then the dimension D of the entire co-variate feature vector is:

D=t×Σ_{d}D_{q}(d)·D_{c}(d)

where t is the size of the historical series. In an embodiment there are unique 120 features and 3 historical series. Therefore, the total dimension of co-variate vector is 120×3=360.

Unlike the univariate model, which forecasts the actual values of the financial metrics, the machine learning model based on the multivariate assumption can be trained on a growth percentage for each forward looking forecast yₜ₊ₕ with respect to the current value yₜ, which reduces the influence of scale on the model. As is to be expected, some companies operate at much larger scales than others and thus the range of possible values for a given financial metric can be extremely large. Using a growth percentage normalizes the scale for each company to attempt to remove bias from the learning process.

In an embodiment, multivariate machine learning model 214 comprises XGBoost. XGBoost is a gradient boosted tree implementation. The time series models cannot use extra features such as macroeconomic data in their predictions. XGBoost is suitable for handling macroeconomic data since it is able to handle missing values. XGBoost also has an advantage in speed of training and performance compared to other machine learning algorithms. However, it should be noted that other machine learning algorithms can be used with the illustrative embodiments.

Even with a high quality of collected quantitative data, missing data issues might arise in the time series. For example, there are instances where a company might not have research development expenses in a particular quarter or year. Different interpolation methods might be used to address this problem. Example of interpolation methods include, e.g., rolling median interpolation, linear interpolation, cubic interpolation, quadratic interpolation, polynomial and Akima interpolation. After bench-marking the accuracy of these methods on some hold-out samples, empirical data indicates a very simple linear interpolation approach to impute null values works well for time series data. Linear interpolation uses two end point values to impute the values in between the end points using linear polynomials.

Multivariate model 214 uses the sector-level data 210 and company-specific data 202 to generate a forecast 216 for the same financial metrics categories over the same time period as the univariate models. In the present example, the time period of the forecast 216 is three years. However, the method of the illustrative embodiments can be applied to other length time periods.

The forecast models 204, 214 can operate at either the quarterly or annual level. To predict annual values, the models can be trained on historical annual data or trained quarterly data and then calculate the future annual values from the predicted future quarterly values. Quarterly prediction models are more aligned with the way financial analysts produce their manual forecasts. Quarterly statistical models are built on more granular data and leverage time series attributes such as seasonality and trends if they persist. Models trained at annual level can fails to capture the seasonality pattern. Furthermore, financial professionals usually conduct the financial forecast at the quarterly level and then sum them up to result annual predictions. XGBoost, Prophet, and deep learning models work well when times series data show strong seasonal behavior. Hold method models are effective for times series data which do not show any seasonal behavior.

The forecasts 208, 216 produced by the univariate models 204 and multivariate model 214 are combined in an ensemble model 218. The ensemble model 218 uses either linear regression 220 or model selection via bucketing 222 to produce a final forecast of the company-level metrics 224 for the specified time period, e.g., three years.

Linear regression model 220 accepts the forecasts from the univariate models 204 and multivariate model 214 and learns the weights for each model forecast. The forecasts for each model acts as an input node. For example, if there are four models that makes predictions p1, p2, p3, and p4, respectively. The linear regression model 220 tries to the learn the respective weights w1, w2, w3, and w4 for those four models. The final prediction value would be:

pFinal=w1*p1+w2*p2+w3*p3+w4*p4

Model selection using bucketing 222 selects one model for a given company out all available models based on their individual performances on a validation dataset for the company in question. All models are assessed on the validation dataset. The model that performs best among the available models is selected, and its forecast is used as the final forecast 224. For example, for a given company, metrics for that company covering the previous year are selected as the validation dataset. If the XGBoost model outperforms all other available model on the validation dataset, XGBoost would be chosen to make the final forecast 224 for the next time period.

Forecasting system 200 can be implemented in software, hardware, firmware or a combination thereof. When software is used, the operations performed by forecasting system 200 can be implemented in program code configured to run on hardware, such as a processor unit. When firmware is used, the operations performed by forecasting system 200 can be implemented in program code and data and stored in persistent memory to run on a processor unit. When hardware is employed, the hardware may include circuits that operate to perform the operations in forecasting system 200.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

These components can be located in a computer system, which is a physical hardware system and includes one or more data processing systems. When more than one data processing system is present in the computer system, those data processing systems are in communication with each other using a communications medium. The communications medium can be a network. The data processing systems can be selected from at least one of a computer, a server computer, a tablet computer, or some other suitable data processing system.

There are three main categories of machine learning: supervised, unsupervised, and reinforcement learning. Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data with no need for labeled datasets. Examples of algorithms used in unsupervised machine learning include k-means clustering, association analysis, and descending clustering.

Whereas supervised and unsupervised methods learn from a dataset, reinforcement learning methods learn from feedback to re-learn/retrain the models. Algorithms are used to train the predictive model through interacting with the environment using measurable performance criteria.

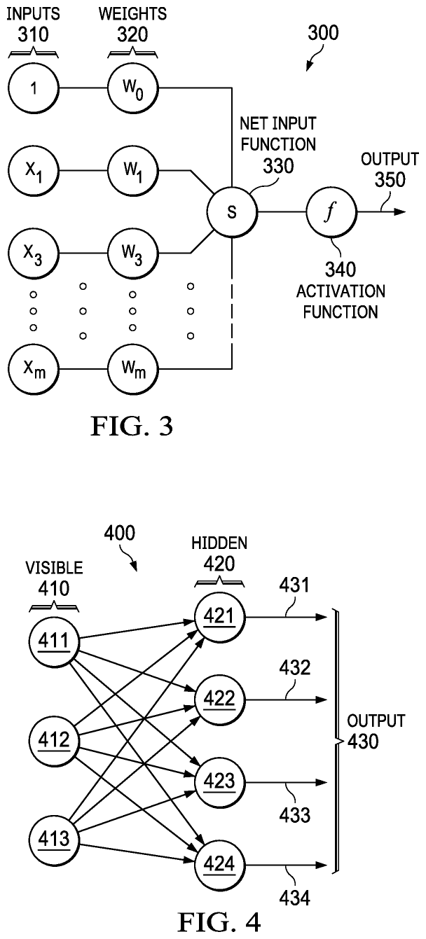

FIG. 3 is a diagram that illustrates a node in a neural network in which illustrative embodiments can be implemented. Node 300 combines multiple inputs 310 from other nodes. Each input 310 is multiplied by a respective weight 320 that either amplifies or dampens that input, thereby assigning significance to each input for the task the algorithm is trying to learn. The weighted inputs are collected by a net input function 330 and then passed through an activation function 340 to determine the output 350. The connections between nodes are called edges. The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer's output acts as the next layer's input.

FIG. 4 is a diagram illustrating a neural network in which illustrative embodiments can be implemented. As shown in FIG. 4, the nodes in the neural network 400 are divided into a layer of visible nodes 410 and a layer of hidden nodes 420. The visible nodes 410 are those that receive information from the environment (i.e. a set of external training data). Each visible node in layer 410 takes a low-level feature from an item in the dataset and passes it to the hidden nodes in the next layer 420. When a node in the hidden layer 420 receives an input value x from a visible node in layer 410 it multiplies x by the weight assigned to that connection (edge) and adds it to a bias b. The result of these two operations is then fed into an activation function which produces the node's output.

In fully connected feed-forward networks, each node in one layer is connected to every node in the next layer. For example, node 421 receives input from all of the visible nodes 411-413 each x value from the separate nodes is multiplied by its respective weight, and all of the products are summed. The summed products are then added to the hidden layer bias, and the result is passed through the activation function to produce output 431. A similar process is repeated at hidden nodes 422-424 to produce respective outputs 432-434. In the case of a deeper neural network, the outputs 430 of hidden layer 420 serve as inputs to the next hidden layer.

Neural network layers can be stacked to create deep networks. After training one neural net, the activities of its hidden nodes can be used as inputs for a higher level, thereby allowing stacking of neural network layers. Such stacking makes it possible to efficiently train several layers of hidden nodes. Examples of stacked networks include deep belief networks (DBN), convolutional neural networks (CNN), recurrent neural networks (RNN), and multi-layer perceptrons (MLP).

FIG. 5 depicts a diagram that illustrates an MLP in accordance with an illustrative embodiment. MLP 500 might be used as one of univariate models 204 in forecasting system 200 shown in FIG. 2.

MLP 500 is a three-layer neural network comprises layers 502, 504, and 506. MLP 500 uses Rectifier Linear Unit (ReLU) as an activation function, which receives an input of values for 12 quarters, [qₜ₋₁₂, qₜ₋₁₁, . . . , qₜ] and predicts values for the subsequent window of 12 quarters, [qₜ₊₁, qₜ₊₂, . . . , qₜ₊₁₂].

Each layer 502, 504, 506 is represented as:

y= [symbol] (WXₜ+b)

where f is the activation function, W is the set of parameters in the layer, Xₜ is the input vector, which can also be the output of the previous layer, and b is the bias vector.

Layer 3 506 uses SoftRelu, also known as SmoothReLU or SoftPlus, which is a nonlinear activation function that takes the form:

SoftReLU(x)=log(1+eₓ)

The SoftReLU can be seen as a smooth version of the ReLU by observing that its derivative is the sigmoid which is a smooth version of the gradient of the ReLU.

FIG. 6 depicts a flowchart illustrating a process for multi-faceted, large-scale forecasting in accordance with an illustrative embodiment. The process in FIG. 6 can be implemented in hardware, software, or both. When implemented in software, the process can take the form of program code that is run by one of more processor units located in one or more hardware devices in one or more computer systems. Process 600 might be implemented in forecasting system 200 shown in FIG. 2.

Process 600 begins by feeding data into differ types of predicting models. A number of univariate models are used to forecast a number of company-level metrics for a company over a specified time period according to company-specific historical data (step 602). The univariate models might comprise at least one of Holt trend method, Prophet model, MLP, or Seq2Seq learning. The company-specific data might include, e.g., revenue, cost of goods sold, research and development expenses, gross margin, depreciation, net working capital, accounts receivable, earnings before interest, taxes, depreciation, and amortization (EBITDA), and management guidance. The company-level metrics forecast by the models might comprise the same categories related to income, balance, and cash flow comprising the company-specific historical data. The univariate models attempt to forecast the future values of these metrics/categories according to their past values.

A multivariate model is also used to forecast the same company-level metrics over the same specified time period according to the company-specific historical data as well as sector-level historical data related to an industry sector to which the company belongs (step 604). The multivariate model takes into account covariate effects the sector-level data might have on company-specific metrics that are not accounted for by the univariate models. Feature engineering might be performed on the sector-level historical data prior to forecasting the second set of company-level metrics. The multivariate model might be, e.g., the XGBoost machine learning model. The sector-level data might comprise at least one of real GDP, CPI, the unemployment rate, interest rates, tax rates, commodity prices, and management guidance.

The forecasts of the univariate models and the multivariate model are combined into an ensemble model (step 606). The company-level metrics are then forecast a final time over the specified time period using the ensemble model (step 608).

The ensemble model might comprise a linear regression model, wherein the forecasts of the univariate models the multivariate model each act as an input node of the ensemble model. The ensemble model then assigns weights to each node.

Alternatively, the ensemble model might use bucketing to compare each of the univariate models and multivariate model against a predetermined validation dataset. The ensemble model then selects a model from among the univariate models and multivariate model that performs best against the validation dataset. The forecast of the selected model is used as the final forecast of the company-level metrics.

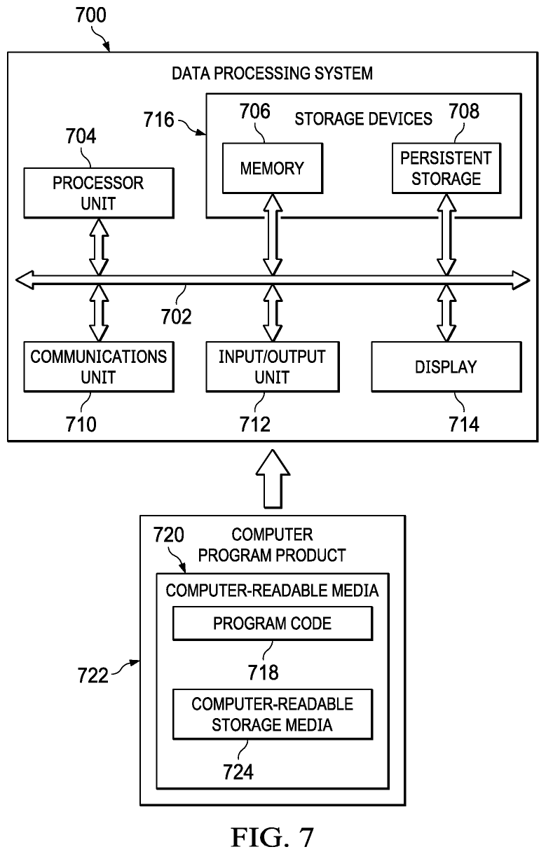

Turning now to FIG. 7, a block diagram of a data processing system is depicted in accordance with an illustrative embodiment. Data processing system 700 can be used to implement server computer 104, server computer 106, client devices 110, in FIG. 1. Further, data processing system 700 can also be used to implement one more components in crisis prediction system 200 in FIG. 2 In this illustrative example, data processing system 700 includes communications framework 702, which provides communications between processor unit 704, memory 706, persistent storage 708, communications unit 710, input/output (I/O) unit 712 and display 714. In this example, communications framework 702 takes the form of a bus system.

Processor unit 704 serves to execute instructions for software that can be loaded into memory 706. Processor unit 704 includes one or more processors. For example, processor unit 704 can be selected from at least one of a multicore processor, a central processing unit (CPU), a graphics processing unit (GPU), a physics processing unit (PPU), a digital signal processor (DSP), a network processor, or some other suitable type of processor.

Memory 706 and persistent storage 708 are examples of storage devices 716. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 716 may also be referred to as computer-readable storage devices in these illustrative examples. Memory 706, in these examples, can be, for example, a random-access memory or any other suitable volatile or non-volatile storage device. Persistent storage 708 may take various forms, depending on the particular implementation.

Persistent storage 708 may contain one or more components or devices. For example, persistent storage 708 can be a hard drive, a solid-state drive (SSD), a flash memory, a rewritable optical disk, a rewritable magnetic tape, or some combination of the above. The media used by persistent storage 708 also can be removable. For example, a removable hard drive can be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that can be connected to data processing system 700. For example, input/output unit 712 may provide a connection for user input through at least one of a keyboard, a mouse, or some other suitable input device. Further, input/output unit 712 may send output to a printer. Display 714 provides a mechanism to display information to a user.

Instructions for at least one of the operating system, applications, or programs can be located in storage devices 716, which are in communication with processor unit 704 through communications framework 702. The processes of the different embodiments can be performed by processor unit 704 using computer-implemented instructions, which may be located in a memory, such as memory 706.

These instructions are referred to as program code, computer usable program code, or computer-readable program code that can be read and executed by a processor in processor unit 704. The program code in the different embodiments can be embodied on different physical or computer-readable storage media, such as memory 706 or persistent storage 708.

Program code 718 is located in a functional form on computer-readable media 720 that is selectively removable and can be loaded onto or transferred to data processing system 700 for execution by processor unit 704. Program code 718 and computer-readable media 720 form computer program product 722 in these illustrative examples. In the illustrative example, computer-readable media 720 is computer-readable storage media 724.

In these illustrative examples, computer-readable storage media 724 is a physical or tangible storage device used to store program code 718 rather than a medium that propagates or transmits program code 718.

Alternatively, program code 718 can be transferred to data processing system 700 using a computer-readable signal media. The computer-readable signal media can be, for example, a propagated data signal containing program code 718. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 720” can be singular or plural. For example, program code 718 can be located in computer-readable media 720 in the form of a single storage device or system. In another example, program code 718 can be located in computer-readable media 720 that is distributed in multiple data processing systems. In other words, some instructions in program code 718 can be located in one data processing system while other instructions in program code 718 can be located in a separate data processing system. For example, a portion of program code 718 can be located in computer-readable media 720 in a server computer while another portion of program code 718 can be located in computer-readable media 720 located in a set of client computers.

The different components illustrated for data processing system 700 are not meant to provide architectural limitations to the manner in which different embodiments can be implemented. The different illustrative embodiments can be implemented in a data processing system including components in addition to or in place of those illustrated for data processing system 700. Other components shown in FIG. 7 can be varied from the illustrative examples shown. The different embodiments can be implemented using any hardware device or system capable of running program code 718.

The description of the different illustrative embodiments has been presented for purposes of illustration and description and is not intended to be exhaustive or limited to the embodiments in the form disclosed. In some illustrative examples, one or more of the components may be incorporated in or otherwise form a portion of, another component. For example, the 706, or portions thereof, may be incorporated in processor unit 704 in some illustrative examples.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A computer-implemented method of forecasting, the method comprising:
using a number of processors to perform the steps of:
forecasting, with a number of univariate models, a number of company-level metrics for a company over a specified time period according to company-specific historical data;
forecasting, with a multivariate model, the company-level metrics over the specified time period according to the company-specific historical data and sector-level historical data related to an industry sector to which the company belongs;
combining the forecasts of the univariate models and the multivariate model into an ensemble model; and
forecasting the company-level metrics over the specified time period with the ensemble model.

2. The method of claim 1, wherein the univariate models comprise at least one of:
Holt trend method;
Prophet model;
multi-layer perceptron; or
sequence-to-sequence learning.

3. The method of claim 1, wherein the multivariate model comprises XGBoost.

4. The method of claim 1, wherein the ensemble model comprises a linear regression model, wherein the forecasts of the univariate models the multivariate model each act as an input node of the ensemble model, and wherein the ensemble model assigns weights to each node.

5. The method of claim 1, wherein the ensemble model:
compares each of the univariate models and the multivariate model against a predetermined validation dataset; and
selects a model from among the univariate models and the multivariate model that performs best against the validation dataset.

6. The method of claim 1, further comprising feature engineering of the sector-level historical data prior to forecasting with the multivariate model.

7. The method of claim 1, wherein the company-specific historical data comprise at least one of:
revenue;
cost of goods sold;
research and development expenses;
gross margin;
depreciation;
net working capital;
accounts receivable;
earnings before interest, taxes, depreciation, and amortization (EBITDA); or
management guidance.

8. The method of claim 1, wherein the sector-level historical data comprise at least one of:
real gross domestic product;
consumer price index;
unemployment rate;
interest rates;
tax rates; or
commodity prices.

9. The method of claim 1, wherein the company-level metrics comprise:
revenue;
cost of goods sold;
research and development expenses;
gross margin;
depreciation;
net working capital;
accounts receivable;
earnings before interest, taxes, depreciation, and amortization (EBITDA); or
management guidance.

10. A system for forecasting, the system comprising:
a storage device configured to store program instructions; and
a number of processors operably connected to the storage device and configured to execute the program instructions to cause the system to:
forecast, with a number of univariate models, a number of company-level metrics for a company over a specified time period according to company-specific historical data;
forecast, with a multivariate model, the company-level metrics over the specified time period according to the company-specific historical data and sector-level historical data related to an industry sector to which the company belongs;
combine the forecasts of the univariate models and the multivariate model into an ensemble model; and
forecast the company-level metrics over the specified time period with the ensemble model.

11. The system of claim 10, wherein the univariate models comprise at least one of:
Holt trend method;
Prophet model;
multi-layer perceptron; or
sequence-to-sequence learning.

12. The system of claim 10, wherein the multivariate model comprises XGBoost.

13. The system of claim 10, wherein the ensemble model comprises a linear regression model, wherein the forecasts of the univariate models the multivariate model each act as an input node of the ensemble model, and wherein the ensemble model assigns weights to each node.

14. The system of claim 10, wherein the ensemble model:
compares each of the univariate models and multivariate model against a predetermined validation dataset; and
selects a model from among the univariate models and multivariate model that performs best against the validation dataset.

15. The system of claim 10, further comprising feature engineering of the sector-level historical data prior to forecasting the second number of company-level metrics.

16. The system of claim 10, wherein the company-specific historical data comprise at least one of:
revenue;
cost of goods sold;
research and development expenses;
gross margin;
depreciation;
net working capital;
accounts receivable;
earnings before interest, taxes, depreciation, and amortization (EBITDA); or
management guidance.

17. The system of claim 10, wherein the sector-level historical data comprise at least one of:
real gross domestic product;
consumer price index;
unemployment rate;
interest rates;
tax rates;
commodity prices; or
management guidance.

18. The system of claim 10, wherein the company-level metrics comprise at least one of:
revenue;
cost of goods sold;
research and development expenses;
gross margin;
depreciation;
net working capital;
accounts receivable;
earnings before interest, taxes, depreciation, and amortization (EBITDA); or
management guidance.

19. A computer program product for forecasting, the computer program product comprising:
a computer-readable storage medium having program instructions embodied thereon to perform the steps of:
forecasting, with a number of univariate models, a number of company-level metrics for a company over a specified time period according to company-specific historical data;
forecasting, with a multivariate model, the company-level metrics over the specified time period according to the company-specific historical data and sector-level historical data related to an industry sector to which the company belongs;
combining the forecasts of the univariate models and the multivariate model into an ensemble model; and
forecasting the company-level metrics over the specified time period with the ensemble model.

20. The computer program product of claim 19, wherein the univariate models comprise at least one of:
Holt trend method;
Prophet model;
multi-layer perceptron; or
sequence-to-sequence learning.

21. The computer program product of claim 19, wherein the multivariate model comprises XGBoost.

22. The computer program product of claim 19, wherein the ensemble model comprises a linear regression model, wherein the forecasts of the univariate models the multivariate model each act as an input node of the ensemble model, and wherein the ensemble model assigns weights to each node.

23. The computer program product of claim 19, wherein the ensemble model:
compares each of the univariate models and multivariate model against a predetermined validation dataset; and
selects a model from among the univariate models and multivariate model that performs best against the validation dataset.

24. The computer program product of claim 19, further comprising feature engineering of the sector-level historical data prior to forecasting with the multivariate model.

25. The computer program product of claim 19, wherein the company-specific historical data comprise at least one of:
revenue;
cost of goods sold;
research and development expenses;
gross margin;
depreciation;
net working capital;
accounts receivable;
earnings before interest, taxes, depreciation, and amortization (EBITDA); or
management guidance.

26. The computer program product of claim 19, wherein the historical macroeconomic data comprise at least one of:
real gross domestic product;
consumer price index;
unemployment rate;
interest rates;
tax rates;
commodity prices; or
management guidance.

27. The computer program product of claim 19, wherein the company-level metrics comprise at least one of:
revenue;
cost of goods sold;
research and development expenses;
gross margin;
depreciation;
net working capital;
accounts receivable;
earnings before interest, taxes, depreciation, and amortization (EBITDA); or
management guidance.

28. The method of claim 1, wherein the univariate models comprise multi-layer perceptrons (MLP), wherein each MLP comprises a number of layers that employ rectifier linear unit (ReLU) activation functions and an output layer that employs a SoftReLU activation function.

29. The system of claim 10, wherein the univariate models comprise multi-layer perceptrons (MLP), wherein each MLP comprises a number of layers that employ rectifier linear unit (ReLU) activation functions and an output layer that employs a SoftReLU activation function.

30. The computer program product of claim 19, wherein the univariate models comprise multi-layer perceptrons (MLP), wherein each MLP comprises a number of layers that employ rectifier linear unit (ReLU) activation functions and an output layer that employs a SoftReLU activation function.
